(19) United States
(12) Patent Application Publication
(10) Pub. No.: US 2026/0302420 A1
(43) Pub. Date: Oct. 1, 2026

(54) DEVICE FOR THERMAL REGULATION, IN PARTICULAR FOR COOLING

(71) Applicant: VALEO SYSTEMES THERMIQUES, Le Mesnil-Saint-Denis (FR)

(72) Inventors: Cédric De-Vaulx, Le Mesnil-Saint-Denis Cedex (FR); Kamel Azzouz, Le Mesnil-Saint-Denis Cedex (FR); Erwan Etienne, Le Mesnil-Saint-Denis Cedex (FR); Jean-Christophe Lhermitte, Le Mesnil-Saint-Denis Cedex (FR); Jeremy Blandin, Le Mesnil-Saint-Denis Cedex (FR)

(73) Assignee: VALEO SYSTEMES THERMIQUES, Le Mesnil-Saint-Denis (FR)

(21) Appl. No.: 18/992,084

(22) PCT Filed: Jul. 3, 2023
(86) PCT No.: PCT/EP2023/068236

§ 371 Date: Jan. 7, 2025

(30) Foreign Application Priority Data
Jul. 7, 2022 (FR) FR2206956

(51) Int. Cl. H01M 10/6568; H01M 10/613

(52) U.S. Cl. CPC H01M 10/6568; H01M 10/613

(57) ABSTRACT

A thermal regulation device, for a component which can release heat during its operation, includes a circulation network for a heat-transfer fluid. The circulation network includes a main heat-transfer fluid flow channel, a secondary heat-transfer fluid flow channel, and a mixing area, into which there open the main channel via a main transverse cross-section, and the secondary channel via a secondary transverse cross-section. The secondary transverse cross-section of the secondary channel is smaller than the main transverse cross-section of the main channel.

The present invention concerns a device for thermal regulation, in particular for cooling, in particular for an electrical component which can give off heat during operation, in particular a device for cooling at least one battery or battery cells of a vehicle, for example a motor vehicle.

The vehicle may be a land vehicle, marine vehicle or air vehicle.

There is known from patent application WO2018109368 a heat exchanger with plates comprising a first and a second plate which are joined in a sealed manner. The first plate is stamped such as to form a plurality of channels which are separated by ribs and are provided with spaced protuberances which act as a flow disturber. The disturbance of the flow, which generates turbulence, makes it possible to create a better exchange of heat with the battery cells to be cooled.

The objective of the invention is in particular to improve the thermal exchanges between the fluid channels and the components to be cooled.

The subject of the invention is thus a thermal regulation device, in particular for cooling, for a component which can release heat during its operation, in particular for an electrochemical energy storage module, this device comprising a circulation network for a heat-transfer fluid, this network comprising:
a main heat-transfer fluid flow channel;
a secondary heat-transfer fluid flow channel;
a mixing area, into which there open the main channel via a main transverse cross-section, and the secondary channel via a secondary transverse cross-section, this secondary transverse cross-section of the secondary channel being smaller than this main transverse cross-section of the main channel, such that the flows of fluid coming from these channels open into the mixing area at different speeds.

The invention is advantageous for the following reasons.

As a result of its smaller secondary transverse cross-section which opens into the mixing area, the secondary channel injects fluid into this mixing area with a speed differential in relation to the fluid obtained from the main channel. This speed differential makes it possible to assist the creation of a mixture of a chaotic type in the mixing area.

The invention thus makes it possible to homogenize the temperature of the fluid over the entire transverse cross-section of the flow, which improves the thermal performance levels of the device.

In the present invention, the mixing can take place at relatively low speeds of the fluid, which mixing is of a chaotic type thanks to the angles selected for the two flows which open into the mixing area. The chaotic mixing principle is used in particular for the mixing of viscous fluids at low speeds. In a known manner, the chaotic mixing is based on the “boulanger transform” for the mixing of the different layers of fluid. For example, according to one way of carrying out this transformation, the layers of fluid are subjected to passive division, then to rotation in bends with different chiralities, and finally to re-combination in order to obtain drawing and folding to ensure homogeneous mixing.

In the invention, the mixture is not necessarily turbulent if the speed, or Reynold's number, does not exceed a certain threshold. The invention can thus permit mixing at a low speed or at a low Reynold's number, typically at a Reynold's number Re lower than 2,000, in particular between 100 and 1,400.

This is particularly advantageous when the thermal regulation device is operating with fluid flow speeds which are insufficient to generate turbulent flows.

This secondary channel is advantageously without obstacles known as “soft dimples”, in order to give precedence to a high speed in this secondary channel.

This secondary channel preferably has a cross-section of passage which is smaller than the cross-section of passage of the main channel.

According to one of the aspects of the invention, the main channel and the secondary channel are adjacent.

According to one of the aspects of the invention, the main channel and the secondary channel are parallel to one another along at least part of their length, in particular along most of their length.

According to one of the aspects of the invention, the main channel and the secondary channel share a common lateral partition.

According to one of the aspects of the invention, the separate flows have a parallel portion before re-joining in the mixing area.

According to one of the aspects of the invention, the main channel and the secondary channel are isolated from one another along the entire length of the secondary channel, and this secondary channel has a length which is sufficient to allow the fluid which circulates in it to accelerate to a speed higher than the speed of flow in the main channel.

According to the invention, the flows which divide in the main channel and the secondary channels, and which re-group in the mixing area, are maintained, in the sense that they do not receive additional flows of fluid on this path between the separation and the mixing area.

According to one of the aspects of the invention, the secondary channel has a fluid inlet and a fluid outlet, with the outlet opening into the mixing area.

According to one of the aspects of the invention, the secondary channel comprises a plurality of successive fluid outlet nozzles which open into a plurality of areas for mixing with the main channel.

According to one of the aspects of the invention, the secondary channel opens onto the mixing area via a convergent nozzle which defines said secondary transverse cross-section.

Thus, the nozzle of the secondary channel makes it possible to accelerate the heat-transfer fluid when it reaches the mixing area.

According to one of the aspects of the invention, the nozzle has a conical form.

According to one of the aspects of the invention, the angle of injection of fluid via the secondary channel is selected in relation to the direction of flow in the main channel in order to assist the creation of a flow of a chaotic type.

According to one of the aspects of the invention, this angle is selected to be between 45° and 90°, the angle being defined in particular in relation to the axis z, i.e. with the axis intersecting the 2 plates perpendicularly.

According to one of the aspects of the invention, the angle of injection in relation to the direction of the flow of the main channel thus assists the creation of a mixture of fluid of a chaotic type.

According to one of the aspects of the invention, the network for circulation of fluid comprises two secondary channels which open successively onto the main mixing area, within which there are mixed the flows of fluid coming from the two secondary channels and the main channel.

According to one of the aspects of the invention, the two secondary channels are positioned on both sides of the main channel.

According to one of the aspects of the invention, the two channels have outlets which face one another, on both sides of the mixing area.

As a variant, on at least one section of the main channel, the circulation network comprises a single secondary channel which is positioned on a side of the main channel.

According to one of the aspects of the invention, the circulation network has alternation of secondary channels, on one side only, on a first section, then on the other side only of the main channel, on a second section, such as to have fluid outlets on one side then on the other of the main channel.

According to one of the aspects of the invention, the circulation network comprises a section in which only one secondary channel is present, and another section in which the two secondary channels are present on both sides of the main channel.

According to one of the aspects of the invention, the secondary channel is shorter than the main channel, in a direction of the flow of fluid in the main channel.

According to one of the aspects of the invention, the inlet of the secondary channel communicates with the main channel, such that this secondary channel can be supplied by fluid coming from the main channel.

Thus, the secondary channel has a fluid connection in the main channel, and re-injects the fluid thus collected, further downstream, into the main channel, after having accelerated the fluid in the secondary channel.

The fluid is thus divided between the main channel and the secondary channel, then, downstream, re-joins in the mixing area, such as to obtain mixing of a chaotic type.

According to one of the aspects of the invention, the separate flows which re-join in the mixing area are exactly two or three. These separate flows are obtained only from the secondary channel, or from two secondary channels and the main channel.

According to one of the aspects of the invention, the inlet of the secondary channel has a convergent form, such as to accelerate the fluid circulating in this secondary channel.

According to one of the aspects of the invention, the inlet of the secondary channel is configured to collect fluid from one of the mixing areas of the main channel.

The invention thus makes it possible to collect fluid mixed in the mixing area, and therefore with a homogeneous temperature, to accelerate it in the secondary channel, and to re-inject it downstream into the following mixing area of the main channel. This makes it possible to achieve a good thermal performance, in particular for a better cooling capacity, as a result of a homogeneous temperature of the fluid, without layers of fluid having substantial temperature gradients.

According to one of the aspects of the invention, the first secondary channel, taken in the direction of the flow in the main channel, is upstream from the first mixing area from among the succession of mixing areas downstream.

According to one of the aspects of the invention, at least one of the secondary channels comprises, in succession, in the direction of the flow of the fluid in this secondary channel, a single fluid inlet and a single fluid outlet towards a mixing area in the main channel.

Thus, the fluid which enters this secondary channel exits into the main channel via the single fluid outlet, downstream.

As a variant, at least one of the secondary channels comprises, in succession in the direction of the flow of the fluid in this secondary channel, a fluid inlet and at least two fluid outlets, each towards a mixing area in the main channel.

Thus, this secondary channel distributes the fluid to several points of the main channel. The global number of mixing areas can be greater than the number of fluid inlets, for example twice or three times this number.

According to one of the aspects of the invention, the main channel comprises at least one separator obstacle, which is designed to separate the flow of fluid in the main channel into two flows.

According to one of the aspects of the invention, the separator obstacle extends along the entire height of the channel.

According to one of the aspects of the invention, in the case of assembled plates, the separator obstacle joins two, lower and upper plates.

As a variant, the separator obstacle extends along only part of the height of the channel.

According to one of the aspects of the invention, the main channel comprises a plurality of separator obstacles, which are designed to separate the flow of fluid in the main channel into two flows, with certain obstacles extending along the entire height of the channel, and certain other obstacles extending along only part of the height of the channel.

According to one of the aspects of the invention, the separator obstacle is placed in the main channel, upstream from the mixing area.

According to one of the aspects of the invention, the separator obstacle has the form of a chevron with the point upstream in the direction of flow of the fluid, in order to separate the flow into two flows.

According to one of the aspects of the invention, the separator obstacle has two branches positioned in the form of a “V”, at least one of which is oriented towards one of the outlets of the secondary channel.

According to one of the aspects of the invention, when two secondary channel outlets face one another, the branches of the separator chevron are oriented respectively towards the two outlets.

When a secondary channel is provided on only one side of the main channel, this main channel can comprise at least one redirection obstacle, which is configured to redirect fluid towards the mixing area, with this redirection obstacle facing the outlet of the secondary channel which injects fluid into this mixing area.

Thus, this mixing area is configured to mix fluid coming from the outlet of the secondary channel, and fluid redirected by this redirection obstacle. In other words, in this example, instead of having two secondary channel outlets facing one another, only a single secondary channel outlet and a redirection obstacle are provided, in order, together, to re-combine the fluid into a mixture, in particular of a chaotic type.

The redirection obstacle is in the form of a bar.

According to one of the aspects of the invention, the redirection obstacle extends parallel to one of the branches in the form of a chevron of the separator obstacle.

According to one of the aspects of the invention, the redirection obstacle extends along the entire height of the channel, or, as a variant, along only part of the height of the channel.

According to one of the aspects of the invention, the main channel comprises one or a plurality of additional obstacles in order to disturb the fluid, in particular in order to generate turbulence for the purpose of improving the exchanges of heat with the component(s).

According to one of the aspects of the invention, these additional obstacles, in particular in the form of a chevron, are situated outside the mixing areas, in particular being situated between one of the mixing areas and one of the separator obstacles.

According to one of the aspects of the invention, these additional obstacles have dimensions which are reduced in relation to the separator obstacles.

These additional obstacles are configured to initiate the turbulence, and to ensure that the fluid is directed well towards the middle of the separator obstacle, in order to be divided there.

According to one of the aspects of the invention, the additional obstacles have the form of a chevron which is inverted in relation to the form of a chevron of the separator obstacle.

According to one of the aspects of the invention, the secondary channel(s) is/are without internal obstacles.

According to one of the aspects of the invention, the device comprises two assembled plates.

According to one of the aspects of the invention, at least one of the plates has stamped portions.

According to one of the aspects of the invention, one of the plates is a lower plate provided with a stamped portion in order to form at least one partition for separation of the main channel and the secondary channel.

According to one of the aspects of the invention, one of the plates is an upper plate provided with a stamped portion in order to form at least one separation obstacle in the main channel.

The subject of the invention is also an assembly comprising at least one component to be cooled, and a thermal regulation device as previously described, the component being placed on the thermal regulation device for cooling thereof.

According to one of the aspects of the invention, the assembly comprises a housing which is designed to receive the components to be cooled.

According to one of the aspects of the invention, the heat-transfer fluid circulating in the channel is selected from among a coolant fluid and glycoled water.

Further characteristics and advantages of the invention will become more clearly apparent from reading the following description, which is given by way of non-limiting illustration, and from the appended drawings, in which:

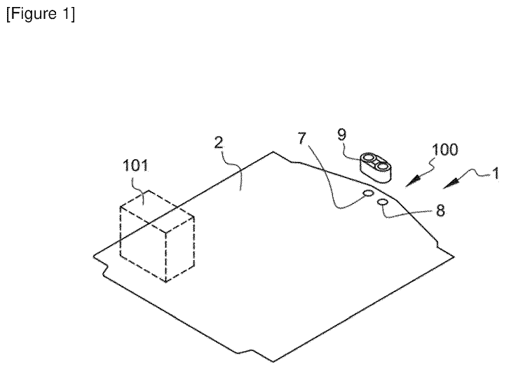

FIG. 1 schematically and partly illustrates a thermal regulation device;

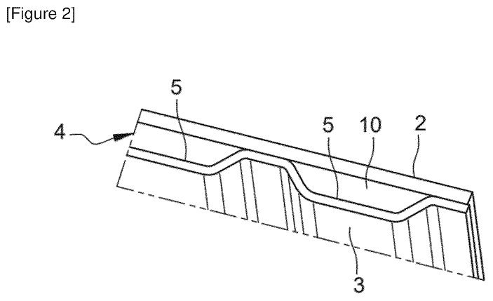

FIG. 2 schematically and partly illustrates a thermal regulation device in cross-section;

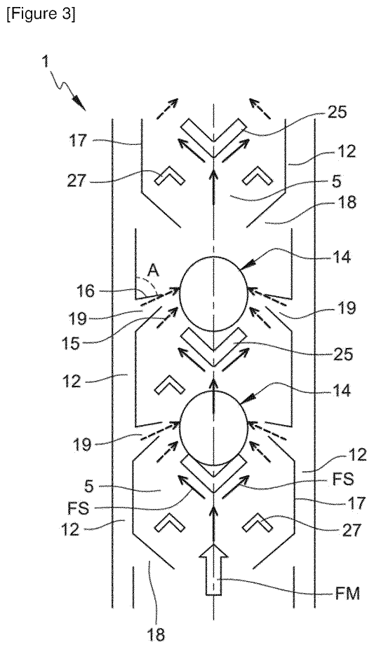

FIG. 3 schematically and partly illustrates a thermal regulation device according to an embodiment of the invention;

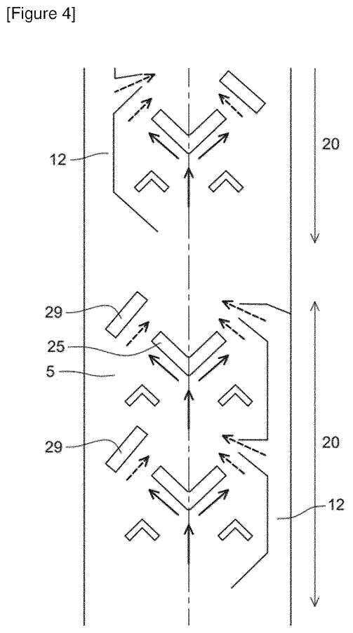

FIG. 4 schematically and partly illustrates a thermal regulation device according to another embodiment of the invention.

FIG. 1 represents an assembly 100 comprising battery cells 101 to be cooled, in this case positioned along a plurality of parallel rows, and a thermal regulation device 1 which is designed to cool the cells 101, which are in thermal contact with a first plate 2, or upper plate 2, of the cooling device 1, as explained hereinafter. This first plate 2 is flat, and the components to be cooled 101, in this case battery cells, are placed on the exterior side of this first plate 2.

The thermal regulation device 1 comprises the upper plate 2 and a lower plate 3 which is assembled with the upper plate 2 in order to form together a circulation network 4 with a plurality of main circulation channels 5 for a liquid heat-transfer fluid, in particular a glycoled water, as shown in FIG. 2. This FIG. 2 shows only the main channels 5.

The channels 5 are supplied with fluid, via a fluid distribution region, not represented, which communicates with a fluid inlet 7 represented in FIG. 1. A fluid outlet 8 is also provided. A flange 9 can be connected to this inlet 7 and this outlet 8, in order to ensure connections with an external fluid circuit, which, inter alia, comprises a pump.

Each channel 5 has a cooling face 10 which faces the component 101 to be cooled.

As can be seen in FIG. 3, by way of non-limiting example, the network 4 comprises, for each main channel 5, two secondary channels 12 and mixing areas 14 into which there open the main channel 5 via a main transverse cross-section 15, and each secondary channel 12 via a secondary transverse cross-section 16, this secondary transverse cross-section 16 of the secondary channel 12 being smaller than this main transverse cross-section 15 of the main channel 5, such that the flows of fluid coming from these channels 5 and 12 open into each mixing area 14 at different speeds.

The mixing area 14 receives fluid coming from the main channel 5 and from the two secondary channels 12.

Because of its smaller secondary transverse cross-section 16 which opens into the mixing area 14, each secondary channel 12 injects fluid into this mixing area 14 with a speed differential in relation to the fluid obtained from the main channel 5. This speed differential makes it possible to assist the creation of a mixture of a chaotic type in the mixing area 14.

Along most of its length in the direction of the flow, each secondary channel 12 has a cross-section of passage which is smaller than the cross-section of passage of the main channel 5.

The main channel 5 is adjacent to the two secondary channels 12 which are on both sides of this main channel 5.

Thus, the main channel 5 and the secondary channels 12 are parallel to one another along most of their length, measured in the general direction of flow FM of the fluid.

The main channel 5 and each of the secondary channels 12 share a common lateral partition 17, such that the main channel 5 and the secondary channels 12 are isolated from one another along the entire length of the secondary channels 12. The partitions 17 extend from one plate 2 to the other plate 3. The partitions 17 can be stamped or added onto one of the plates 2, 3.

Each secondary channel 12 has in succession a fluid inlet 18 and two fluid outlets 19, each outlet 19 being in the form of an outlet nozzle which opens into one of the mixing areas 14.

The two opposite secondary channels 12 have outlets 19 which face one another on both sides of the corresponding mixing area 14.

Each outlet nozzle 19 has a convergent conical form which defines said secondary transverse cross-section 16.

Thus, the nozzle 19 of the secondary channel 12 makes it possible to accelerate the heat-transfer fluid when it reaches the mixing area 14.

The angle of injection A of fluid by the secondary channel 12 is selected in relation to the general direction of the flow FM in the main channel 5 so as to assist the creation of a flow of a chaotic type.

This angle A is selected to be between 45° and 90°.

It should be noted that the secondary channels 12 are shorter than the main channel 5, in a direction of the flow of fluid FM.

The inlet 18 of each secondary channel 12 communicates with the main channel 5, such that this secondary channel 12 can be supplied by fluid coming from the main channel 5.

Thus, each secondary channel 12 has a fluid connection in the main channel 5, and re-injects the fluid thus collected, further downstream, into the main channel 5, after having accelerated the fluid in the secondary channel 12.

The fluid is thus divided between the main channel 5 and the secondary channel 12, then is re-combined downstream in the mixing area 14. This makes it possible to carry out mixing of a chaotic type.

The inlet 18 of each secondary channel 12 has a convergent form, such as to accelerate the fluid circulating in this secondary channel 12.

The inlet 18 of the secondary channel 12 is configured to collect fluid from one of the mixing areas 14 of the main channel 5.

The invention thus makes it possible to collect fluid mixed in the mixing area 14, and therefore with a homogeneous temperature, to accelerate it in the secondary channel 12, and to re-inject it downstream, into the following mixing area 14 of the main channel 5.

The first secondary channel 12, taken in the direction of the flow FM in the main channel, is upstream from the first mixing area 14 from among the succession of mixing areas 14 downstream.

In a variant not represented, at least one of the secondary channels 12 comprises, in succession in the direction of the flow of the fluid in this secondary channel, a single fluid inlet 18 and a single fluid outlet 19 towards a mixing area 14 in the main channel 5. Thus, the fluid which enters this secondary channel 12 exits into the main channel 5 via the single fluid outlet 19 downstream.

In the example described, the main channel 5 comprises, at each transverse cross-section 15, a separator obstacle 25, which is designed to separate the flow of fluid into the main channel 5 into two flows FS.

Each separator obstacle 25 extends along only part of the height of the channel 5. The height is measured perpendicularly to a plane which contains the main channel 5 and the secondary channels 12.

Each separator obstacle 25 is placed in the main channel 5 upstream from the mixing area 14.

The separator obstacles 25 have the form of a chevron with the point upstream, in the direction of flow of the fluid, in order to separate the flow into two flows FS. The separator obstacles 25 are placed in the center of the channel 5.

Thus, each separator obstacle 25 has two branches positioned in the form of a “V” oriented with respect to the two outlets 19 which face one another.

The main channel 5 comprises a plurality of additional obstacles 27, in order to disturb the fluid, in particular in order to generate turbulence, for the purpose of improving the exchanges of heat with the components 101 to be cooled.

These additional obstacles 27 in the form of a chevron, are situated outside the mixing areas 14, each being situated between one of the mixing areas 14 and one of the separator obstacles 25.

These additional obstacles 27 have dimensions which are reduced in relation to the separator obstacles 25.

These additional obstacles 27 are configured to initiate the turbulence, and to ensure that the fluid is directed well towards the middle of the separator obstacle 25, in order to be divided there.

In the example described, the additional obstacles 27 are positioned in pairs facing each separator obstacle 25.

The additional obstacles 27 are in the form of a chevron, which is inverted in relation to the form of a chevron of the separator obstacle 25.

The secondary channels 12 are without internal obstacles.

At least one of the plates, i.e. the lower plate 3, has portions which are stamped in order to form the obstacles 25 and 27, and define a plurality of main channels 5.

The lower plate 3 is provided with a stamped portion in order to form the lateral separation partitions 17 of the main channel 5 and of the secondary channels 12.

As a variant, as illustrated in FIG. 4, the circulation network 4 comprises, on each section 20 of the main channel 5, a single secondary channel 12 which is positioned on a side of the main channel 5.

Thus, the circulation network 4 has alternation of secondary channels 12, on one side only, on a first section 20, then on the other side only of the main channel, on a second section 20, such as to have fluid outlets 19 on one side then on the other side of the main channel 5.

The main channel 5 comprises a succession of redirection obstacles 29 which are configured to redirect fluid towards the associated mixing area 14, with this redirection obstacle 29 facing the outlet 19 of the secondary channel which, from one side of the channel 5, injects fluid into this mixing area 14.

Thus, this mixing area 14 is configured to mix fluid coming from the outlet 19 of the secondary channel 12, and fluid redirected by this redirection obstacle 29. In other words, in this example, instead of having two secondary channel outlets 19 which face one another, a single secondary channel outlet 19 and a redirection obstacle 29 are provided, in order together to re-combine the fluid into a mixture, in particular of a chaotic type.

The redirection obstacle 29 is in the form of a bar.

The redirection obstacle 29 extends parallel to one of the branches in the form of a chevron of the separator obstacle 25.

The redirection obstacle 29 extends along the entire height of the channel 5, or, as a variant, over only part of the height of the channel 5.

1. A thermal regulation device, for a component which can release heat during its operation, the device comprising a circulation network for a heat-transfer fluid, the circulation network comprising:
a main heat-transfer fluid flow channel;
a secondary heat-transfer fluid flow channel; and
a mixing area, into which there open the main channel via a main transverse cross-section, and the secondary channel via a secondary transverse cross-section,
wherein the secondary transverse cross-section of the secondary channel is smaller than the main transverse cross-section of the main channel, such that the flows of fluid coming from these channels open into the mixing area at different speeds.

2. The thermal regulation device as claimed in claim 1, wherein the main channel and the secondary channel are adjacent.

3. The thermal regulation device as claimed in claim 2, wherein the main channel and the secondary channel share a common lateral partition.

4. The thermal regulation device as claimed in claim 1, wherein the secondary channel comprises a plurality of successive fluid outlet nozzles which open into a plurality of mixing areas, each nozzle being convergent.

5. The thermal regulation device as claimed in claim 1, wherein an angle of injection of fluid by the secondary channel is selected in relation to a general direction of the flow in the main channel so as to assist a creation of a flow of a chaotic type, the angle being selected to be between 45° and 90°.

6. The thermal regulation device as claimed in claim 1, wherein the network for circulation of fluid comprises two secondary channels which open successively onto the same mixing area, within which there are mixed the flows of fluid coming from the two secondary channels and the main channel.

7. The thermal regulation device as claimed in claim 1, wherein on at least one section of the main channel, the circulation network comprises a single secondary channel which is positioned on a side of the main channel.

8. The thermal regulation device as claimed in claim 7, wherein the circulation network has alternation of secondary channels, on one side only, on a first section, then on the other side only of the main channel, on a second section, such as to have flows of fluid on one side then on the other of the main channel.

9. The thermal regulation device as claimed in claim 1, claims, wherein an inlet of the secondary channel is configured to collect fluid from one of the mixing areas of the main channel.

10. The thermal regulation device as claimed in claim 1, claims, wherein the main channel comprises at least one separator obstacle, in the form of a chevron, which is designed to separate the flow of fluid in the main channel into two flows.

11. The thermal regulation device as claimed in claim 7, wherein, when a secondary channel is provided on only one side of the main channel, the main channel comprises at least one redirection obstacle, in the form of a bar, which is configured to redirect fluid towards the mixing area, with this redirection obstacle facing an outlet of the secondary channel which injects fluid into this mixing area.

12. The thermal regulation device as claimed in claim 1, wherein the main channel comprises one or a plurality of additional obstacles, in the form of a chevron, in order to disturb the fluid, in order to generate turbulence for the purpose of improving exchanges of heat with the component(s).

13. The thermal regulation device as claimed in claim 1, wherein the device comprises two assembled plates.

14. An assembly comprising at least one component to be cooled and the thermal regulation device as claimed in claim 1, the component being placed on the thermal regulation device for cooling thereof.
